(19) United States
(12) Patent Application Publication
(10) Pub. No.: US 2010/0025369 A1
(43) Pub. Date: Feb. 4, 2010

(54) PLASMA PROCESSING APPARATUS AND PLASMA PROCESSING METHOD

(75) Inventors: Nobuyuki NEGISHI, Tokyo (JP); Masaru Izawa, Tokyo (JP); Kenji Maeda, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/202,642

(22) Filed: Sep. 2, 2008

(30) Foreign Application Priority Data
Jul. 30, 2008 (JP) 2008-196726

(51) Int. Cl. G01L 11/02

(52) U.S. Cl. 216/60; 156/345.29

(57) ABSTRACT

To monitor the thickness of a focus ring consumed during wafer processing. A plasma processing apparatus includes a vacuum chamber 1, workpiece mounting means 5, high frequency electric power introducing means 4 and radio-frequency bias electric power introducing means 7 and processes a surface of a workpiece 6 using a plasma that is converted from a gas introduced into the vacuum chamber 1 by the action of a high frequency electric power introduced by the high frequency electric power introducing means 4. The plasma processing apparatus further includes an annular member 11 surrounding the workpiece 6 mounted on the workpiece mounting means 5, and a pair of tubes having an aspect ratio of 3 or higher and disposed on a side wall of the vacuum chamber 1 to face each other. Each tube is vacuum-sealed at a tip end thereof with a glass material. One of the tubes has a light source 15 disposed facing to the interior of the vacuum chamber on the atmosphere side of the glass material, and the other tube has light receiving means 16 disposed facing to the interior of the vacuum chamber on the atmosphere side of the glass material. The light receiving means 16 receives light passing across the surface of the annular member 11.

The present application is based on and claims priority of Japanese patent application No. 2008-196726 filed on Jul. 30, 2008, the entire contents of which are hereby incorporated by reference.

### BACKGROUND OF THE INVENTION

1. Field of the Invention

The present invention relates to a dry etching apparatus (a plasma processing apparatus) and an etching method (a plasma processing method) used for etching of an interlayer insulating film in an etching process using a plasma processing apparatus. For example, it relates to a plasma processing apparatus and a plasma processing method that can prevent a tilt of a hole, which occurs especially at an edge of a workpiece in a case where the pattern to be formed in the workpiece is a high-aspect-ratio contact hole.

2. Description of the Related Art

For memory devices, such as the dynamic random access memory (DRAM), it is important to maintain the capacitor capacitance when the packaging density increases. In general, capacitor structures are classified into two types: the trench capacitor in which a deep groove is formed in a silicon substrate; and the stack capacitor in which a capacitor is formed on a transistor. For both capacitors, the capacitance can be increased by increasing the height of the capacitor or reducing the thickness of the dielectric film. The height of the capacitor depends on the etching quality. On the other hand, reduction of the thickness of the dielectric film has already reached the limit of the silicon oxide film, and therefore, further reduction of the thickness of the dielectric film depends the development of a high dielectric constant material. To reduce the etching difficulty, there has been attempted an approach to increasing the capacitor capacitance of a low-aspect-ratio pattern by using parts on the opposite sides of the pattern as electrodes. However, it is difficult to ensure that the bottom part of the pattern of a miniaturized capacitor has adequate mechanical strength by itself, and there is a problem that adjacent capacitors come into contact with each other. Therefore, it is considered that capacitor structures formed inside a pattern will be mainstream, and formation of high-aspect-ratio patterns will continue. In 2011, the International Technology Roadmap for Semiconductor will require that the aspect ratio be substantially increased to about 50, and patterns having such a high aspect ratio be formed in large-diameter wafers having a diameter of 300 mm or more uniformly to a distance of 3 mm from the wafer edge. The distance of 3 mm from the wafer edge will probably be desired to be reduced, and it will be ultimately required that patterns of high quality be formed to a distance of 0 mm from the wafer edge.

Next, a method of dry etching will be described. The dry etching is a technique of selectively etching a desired film without etching a mask material, such as a resist, or a wiring layer or a base substrate under a via, a contact hole, a capacitor or the like by externally applying a high frequency electric power to an etching gas introduced into a vacuum chamber to produce a plasma, and causing a reaction of reactive radicals or ions produced in the plasma on a wafer with high precision.

In formation of a via, a contact hole or the capacitor described above, a mixture gas of a fluorocarbon gas, such as CF4, CHF3, C2F6, C3F6O, C4F8, C5F8 and C4F6, an inert gas, such as Ar, oxygen gas and the like is introduced as a plasma gas, a plasma is produced under a pressure ranging from 0.5 Pa to 10 Pa, and ions incident on a wafer is accelerated by a radio-frequency bias (RF bias) electric power applied to the wafer to increase the energy of the ions to 0.5 kV to 5.0 kV. In this process, an abnormality in shape of the wafer edge poses a problem. FIG. 5 shows states of an edge region of a wafer. A silicon focus ring 11, which is an annular member, is disposed along the perimeter of a wafer 6. Of course, the RF bias electric power is applied to the focus ring. FIG. 5A shows a state of a plasma sheath surface in a case where the surface of the focus ring and the surface of the wafer are substantially flush with each other. In this example, it is assumed that an equal RF bias electric power per unit area is applied to the wafer 6 and the focus ring 11. In this case, as shown by the dashed line, the ion sheath surface on the wafer and the ion sheath surface on the focus ring are located at the same level, and ions are incident vertically on the wafer 6 over the entire surface including the edge part thereof. As a result, vertical holes are formed even in the edge part of the wafer, as shown in FIG. 6(A). However, as the number of wafers processed increases, the focus ring 11 is also shaved off by the action of the fluorine radicals or ions incident thereon. In this case, for example, it is considered that the surface of the focus ring 11 is located at a lower level than the surface of the wafer 6 as shown in FIG. 5B. If an equal RF bias electric power per unit area is still applied to the wafer 6 and the focus ring 11 in this case, the ion sheath surface on the focus ring is lowered by the thickness of consumption of the focus ring because the ion sheath formed on the wafer and the ion sheath formed on the focus ring have the same thickness, as shown in FIG. 5B. As a result, the ion sheath is deformed in the part close to the wafer edge, and ions are obliquely incident on this area of the wafer in a direction to the center of the wafer. FIG. 6(B) shows the shapes of holes formed in the part close to the wafer edge in this case. As can be seen from this drawing, in the part close to the wafer edge in which ions are obliquely incident on the wafer, the angle of tilt of the holes gradually increases as the holes become closer to the wafer edge.

To avoid the problem, it has been proposed techniques of maintaining a uniform plasma sheath surface by applying different RF bias electric powers to a focus ring and a wafer (see Japanese Patent Laid-Open Publication No. 2004-241792 (Patent Document 1), for example). According to these techniques, the ion sheath on the focus ring and the ion sheath on the wafer can be made flush with each other.

However, according to these inventions, the thickness of the focus ring consumed during wafer processing cannot be monitored, and wafer processing cannot be halted for maintenance when the amount of consumption of the focus ring becomes equal to or higher than a prescribed value. Furthermore, the amount of consumption of the focus ring cannot be fed back to set the bias applied to the focus ring at an optimal value.

### SUMMARY OF THE INVENTION

Thus, an object of the present invention is to provide a plasma processing apparatus and a plasma processing method that can manufacture a high-quality semiconductor device even at an edge of a wafer regardless of the processing time by simply monitoring the thickness of consumption of a focus ring and performing maintenance based on the value of the thickness or setting a RF bias electric power applied to the focus ring at an optimal value.

According to the present invention, any of the aspects thereof described below can be used to monitor the thickness of consumption of an annular member disposed along the perimeter of a wafer (workpiece). Thus, a high-quality semiconductor device is manufactured even at a wafer edge part regardless of the processing time by controlling the RF bias electric power applied to the annular member.

According to a first aspect of the present invention, a light source and light receiving means for receiving direct light from the light source are installed on a side wall of a vacuum chamber. In this case, the height of a focus ring disposed between the light source and the light receiving means, that is, the amount of consumption (thickness of consumption) of the focus ring can be detected by detecting a variation of the amount of light detected by the light receiving means due to a variation of the height of the focus ring, and thus, the problem described above can be solved. Specifically, the light path from the light source is arranged to be parallel with the surface of the focus ring, and the light passing across the surface of the focus ring is received by the light receiving means disposed on the light path. More specifically, two pairs of light sources and light receiving means are provided, the light paths of the pairs are arranged to be parallel with the surface of the wafer and the surface of the focus ring, respectively, and the light passing across the surface of the wafer and the light passing across the surface of the focus ring are received by the light receiving means disposed on the respective light paths. The amount of consumption of the focus ring can be detected by monitoring the difference between the amounts of light received by the two light receiving means.

According to a second aspect of the present invention, a light source and light receiving means that receives direct light from the light source after being reflected from a focus ring are installed on a side wall of a vacuum chamber. In this case, the height of a focus ring disposed between the light source and the light receiving means, that is, the amount of consumption of the focus ring can be detected by detecting a variation of the position of light detected by the light receiving means due to a variation of the height of the focus ring, and thus, the problem described above can be solved. Specifically, the light path is arranged not to pass over a wafer, so that the amount of consumption at a desired position can be accurately detected even if the degree of consumption of the focus ring varies concentrically.

According to a third aspect of the present invention, a plasma processing method comprises a step of detecting the amount of consumption of a focus ring and a step of calculating the thickness of ion sheathes formed on a surface of a wafer and a surface of the focus ring, and the height difference between the ion sheathes formed on the wafer and the focus ring is estimated based on the result of the calculation. A RF bias electric power applied to the focus ring is controlled taking the ion sheath height difference into consideration, thereby solving the problem described above.

A plasma processing apparatus and a plasma processing method according to the present invention involve simply monitoring the amount of consumption of a focus ring disposed along the perimeter of a wafer. Thus, for example, in a case where high-aspect-ratio contact holes are to be formed as a pattern, the amount of the RF bias electric power separately applied to the focus ring to reduce the height difference between the ion sheaths formed on the edge of the wafer and on the focus ring disposed surrounding the wafer can be adjusted, thereby stably suppressing tilt of holes, which occurs especially at the edge of the wafer for a long time. Alternatively, when the monitored amount of consumption of the focus ring exceeds or is about to exceed a predetermined value, a signal to stop the processing can be provided, thereby reducing the number of inferior products.

### BRIEF DESCRIPTION OF THE DRAWINGS

FIG. 1 is a schematic vertical cross-sectional view showing a configuration of a plasma processing apparatus that detects the amount of consumption of a focus ring using a transmitted laser beam;

FIG. 2 is a horizontal cross-sectional view showing a light source and light receiving means shown in FIG. 1;

FIG. 3A is a graph showing a relationship between the amount of consumption of the focus ring and the amount of light detected by the light receiving means;

FIG. 3B is a graph showing a relationship between the RF bias voltage and the thickness of a sheath formed on a wafer surface or a focus ring surface;

FIGS. 4A and 4B are cross-sectional views for illustrating optical paths in the case of the configuration shown in FIG. 2;

FIGS. 4C and 4D are cross-sectional views for illustrating optical paths in the case of the configuration shown in FIG. 9;

FIG. 5A is a schematic diagram for illustrating the state of ion sheathes formed on the wafer surface and the focus ring surface in the case where the focus ring is not consumed;

FIG. 5B is a schematic diagram for illustrating the state of ion sheathes formed on the wafer surface and the focus ring surface in the case where the focus ring is consumed;

FIG. 6 includes diagrams for illustrating a tilt occurring in hole formation;

FIG. 7 is a flowchart for illustrating setting of the RF bias electric power applied to the focus ring;

FIG. 8 is a schematic diagram for illustrating the state of ion sheathes formed on the wafer surface and the focus ring surface in the case where the focus ring is consumed;

FIG. 9A is a schematic diagram showing a case where two pairs of light sources and light receiving means are provided, and there are two light receiving means;

FIG. 9B is a schematic diagram showing case where two pairs of light sources and light receiving means are provided, and there is only one light receiving means shared by the two light sources;

FIG. 10 is a schematic vertical cross-sectional view showing a configuration of a plasma processing apparatus that detects the amount of consumption of a focus ring using a reflected laser beam;

FIG. 11 includes schematic diagrams for illustrating paths of the reflected laser beam in the cases where the focus ring is consumed and where the focus ring is not consumed;

FIG. 12 is a vertical cross-sectional view for illustrating a case where the optical path in the configuration shown in FIG. 10 runs over the wafer; and

FIG. 13 includes schematic diagrams for illustrating paths of the reflected light in the configuration shown in FIG. 12 in the cases where the focus ring is consumed and where the focus ring is not consumed.

### DETAILED DESCRIPTION OF THE PREFERRED EMBODIMENTS

### First Embodiment

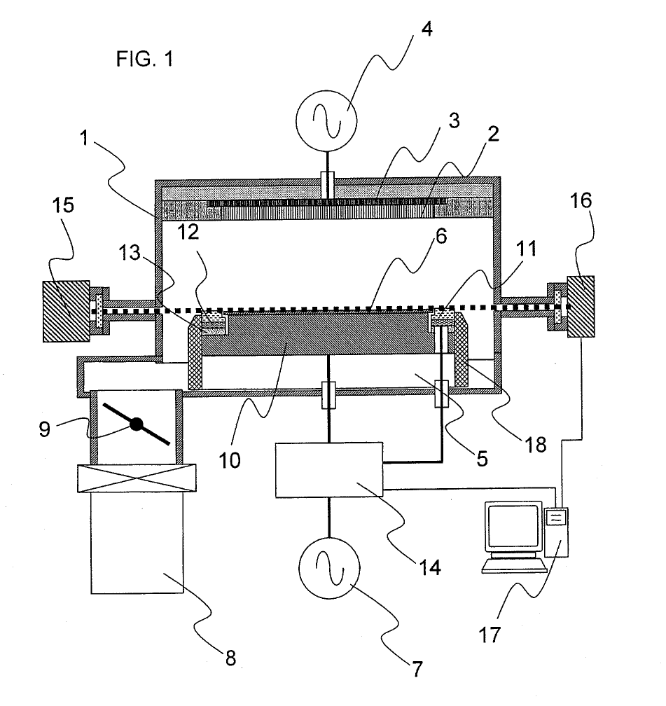

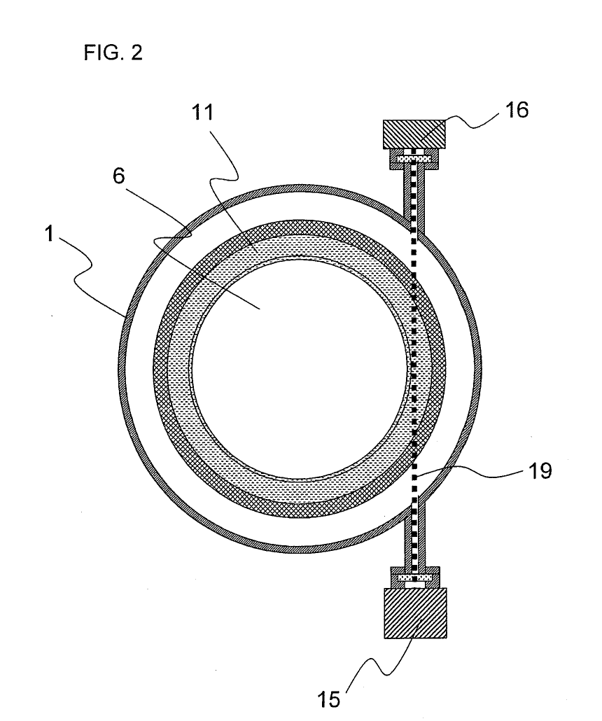

In the following, a first embodiment of the present invention will be described with reference to the drawings. In the first embodiment, there will be described a method of monitoring the amount of consumption of a focus ring using a laser as a light source. FIGS. 1 and 2 are schematic diagrams for illustrating a configuration of a plasma processing apparatus (an etching apparatus) used in the first embodiment. FIG. 1 is a vertical cross-sectional view of the plasma processing apparatus, and FIG. 2 is a horizontal cross-sectional view of the plasma processing apparatus taken along the plane of a wafer. The plasma processing apparatus has a vacuum chamber 1 and a shower plate 2, an upper electrode 3 and a lower electrode 5 housed in the vacuum chamber 1. Furthermore, the vacuum chamber 1 has an evacuation system 8 connected to the vacuum chamber 1 via a conductance valve 9, a light source 15, and light receiving means 16. An annular member 11 (referred to as focus ring hereinafter), a conductor ring 12 and an insulator ring 13 are mounted on the lower electrode 5, and a susceptor 18 is disposed to surround the periphery of these components. A RF bias electric power supply 7 applies a RF bias voltage to the lower electrode 5 and the conductor ring 12 via a distributor 14. A plasma generating high frequency power supply 4 is connected to the upper electrode 3 and supplies a plasma generating electric power into the vacuum chamber 1. The output of the light receiving means 16 is input to a control PC (calculating means) 17, and the control PC controls the distribution of the voltage applied to the lower electrode 5 and the focus ring 11.

The light source 15 and the light receiving means 16 are disposed one and the other of a pair of tubes, which are disposed on a wall of the vacuum chamber to face each other, respectively. Each tube has an aspect ratio of 3 or higher, is vacuum-sealed at a tip end with a translucent material (a glass material), and has the light source 15 or the light receiving means 16 disposed on the atmosphere side of the translucent material. The light source 15 may be a laser light source. The light receiving means 16 may be light receiving means having an array of a plurality of light receiving elements of various types, such as a photo diode, or a CCD element.

In this embodiment, a source gas introduced through a gas inlet pipe (not shown) is supplied into the vacuum chamber 1 through the shower plate 2, and a high frequency electric power is applied from the plasma generating power supply 4 to the upper electrode 3, thereby generating a plasma. A workpiece 6 is placed on the lower electrode 5. The lower electrode 5 is connected to the 4-MHz RF bias electric power supply 7, which produces a RF bias voltage Vpp on the workpiece 6, and ions are attracted to the workpiece 6 by the action of the RF bias voltage Vpp to etch the workpiece 6. In this embodiment, a mixture gas of C4F6, Ar and O2 is introduced into the vacuum chamber as the source gas, and the pressure of the source gas is adjusted to 15 mTorr by the conductance valve 9 disposed between the evacuation system 8 and the vacuum chamber to etch a silicon oxide film.

At the center of the lower electrode 5, which serves as the workpiece mounting means, a chuck part (a semiconductor wafer holding mechanism) 10 for holding the semiconductor wafer 6, which is the workpiece, is disposed. The chuck mechanism is an electrostatic chuck, for example. The surface of the electrostatic chuck for holding the wafer is composed of a ceramic thin film of aluminum nitride or the like and an aluminum substrate below the ceramic thin film, and the high frequency electric power from the RF bias electric power supply 7 and a DC voltage supplied from a direct-current voltage power supply via a low frequency pass filter formed by a choke coil or the like (not shown) are applied to the substrate. Alternatively, the chuck part 10 may be a mechanical chuck that mechanically clamps the semiconductor wafer 6 with a clamping member. Although not shown, the electrostatic chuck has a heat transfer gas supply hole, and the efficiency of heat conduction from the lower electrode 5 to the semiconductor wafer 6 can be improved by supplying helium gas, for example. Furthermore, to prevent the RF bias electric power applied to the chuck part 10 from leaking to the periphery, a susceptor 18 made of an insulator is provided.

Furthermore, the focus ring 11 is disposed along the perimeter of the lower electrode 5. The focus ring 11 is made of a conductor or a semiconductor or an insulator. In this embodiment, the focus ring 11 is made of silicon. The conductor ring 12 through which the RF bias electric power is applied to the focus ring is disposed under the focus ring 11, and the insulator ring 13 for electrically insulating the conductor ring 12 from the chuck part 10 is disposed under the conductor ring 12. The electric power from the RF bias electric power supply 7 can be distributed by the distributor 14 composed of a capacitor so that the voltage applied to the workpiece 6 via the lower electrode 5 and the voltage applied to the focus ring 11 differ from each other. The distributor 14 is means of controllably distributing the RF bias voltage from the RF bias electric power supply 7 between the workpiece 6 and the focus ring 11. The distributor 14 helps to make the radical distribution in the plasma uniform and to keep the height of ion sheathes formed on the wafer surface and the focus ring surface uniform. In this case, the split ratio (distribution ratio) of electric power depends on ratio between the capacitance of the sheath formed on the wafer surface and the capacitance of the sheath formed on the focus ring surface and the capacitance of the capacitor described above, and therefore, the capacitor is preferably a variable capacitor in order to change the RF bias electric power applied to the focus ring.

As shown in FIG. 2, the light source 15 and the light receiving means 16 are disposed so that part of the laser beam passes across the surface of the focus ring 11 at a position outside of the wafer 6, and the remaining part of the laser beam is blocked by the focus ring 11.

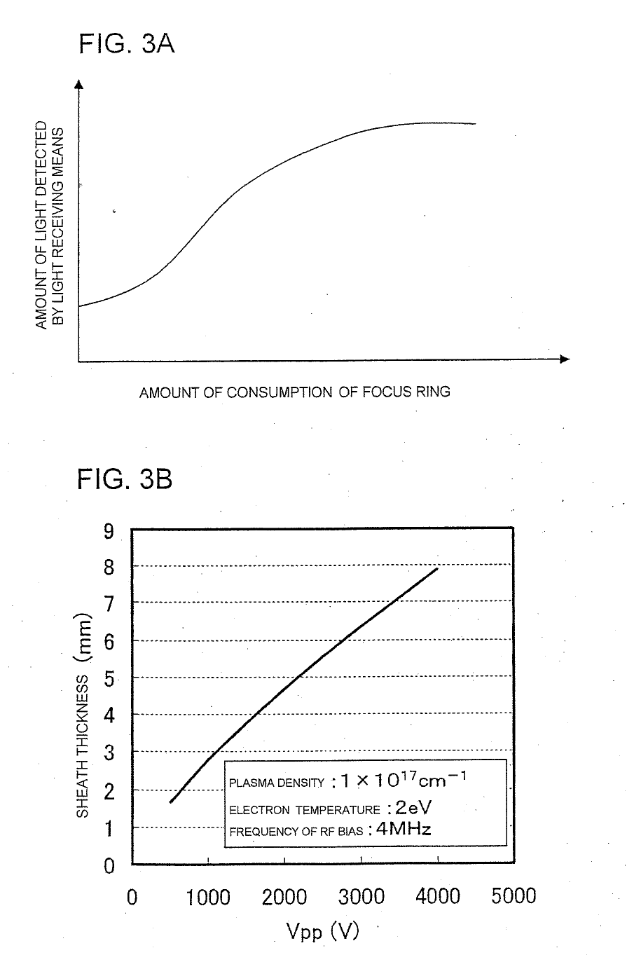

Referring to FIG. 3A, a relationship between the amount of consumption of the focus ring 11 and the amount of light detected by the light receiving means 16 is as follows. That is, the amount of light detected by the light receiving means 16 is low when the amount of consumption of the focus ring 11 is low, increases as the amount of consumption of the focus ring 11 increases, and eventually is saturated.

Referring to FIG. 3B, a relationship between the RF bias voltage Vpp and the thickness of the sheath on the wafer surface or the focus ring surface is as follows. The sheath thickness is small when the RF bias voltage Vpp is low and is large when the RF bias voltage Vpp is high.

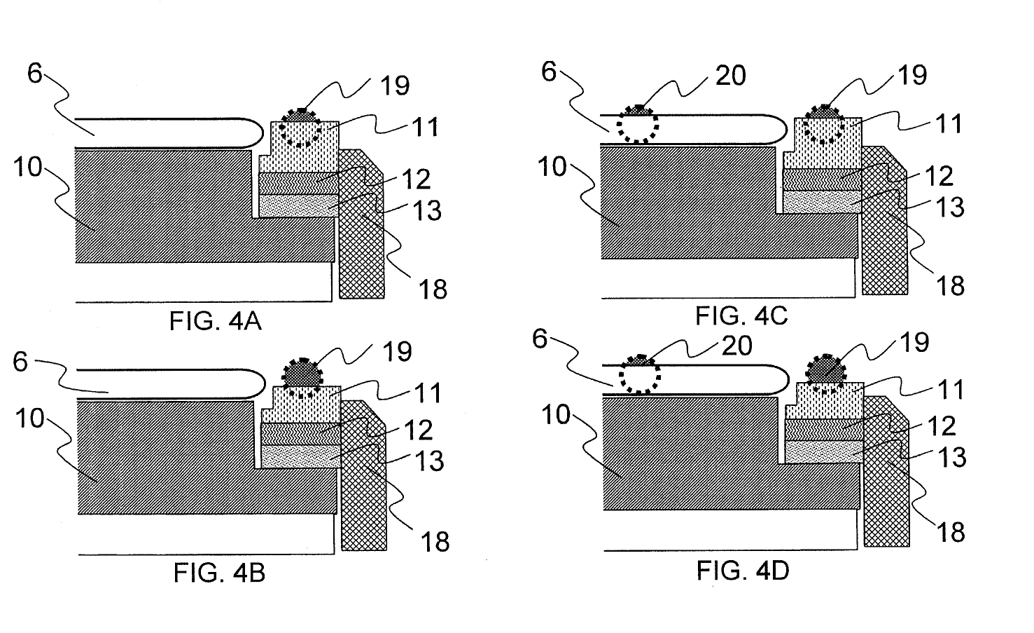

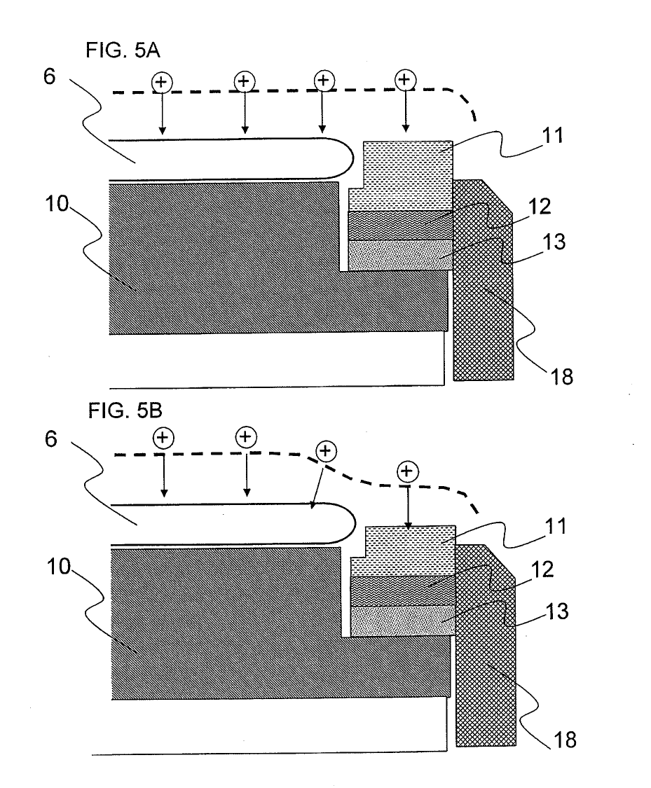

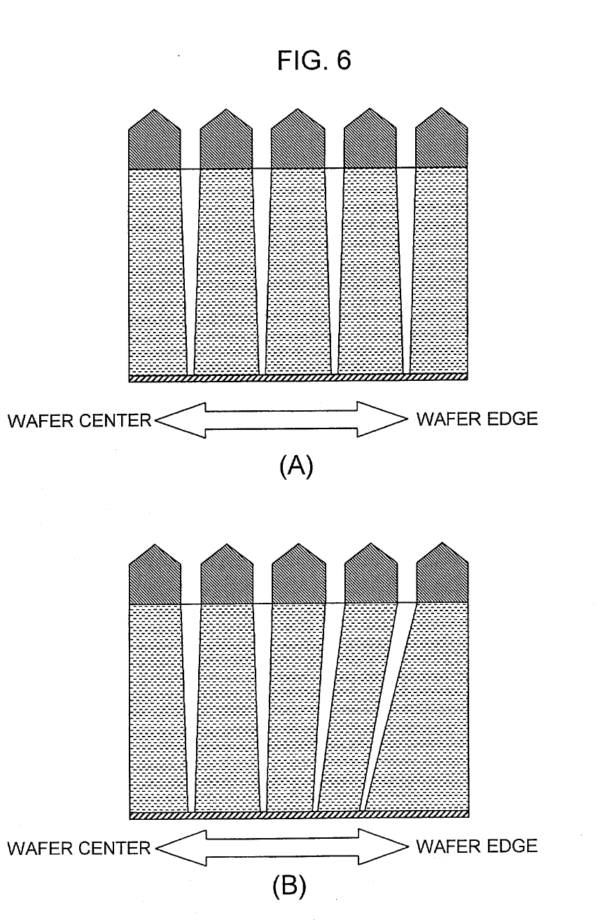

Next, there will be described a method of detecting the amount of consumption of the focus ring and a method of controlling the amount of the RF bias electric power applied to the focus ring based on the result of the detection. A laser beam 19 emitted from the light source 15 shown in FIG. 1 disposed on a side wall of the chamber (the vacuum chamber) passes across the surface of the focus ring 11 and is incident on the light receiving means 16 similarly disposed on the side wall of the chamber. If the focus ring is not consumed, as shown in FIG. 4A, most part of the laser beam 19 is blocked by the focus ring, so that the amount of light incident on the light receiving means 16 is small. In this state, the ion sheath formed on the front surface of the wafer and the ion sheath formed on the front surface of the focus ring have equal thicknesses as shown in FIG. 5A, and vertical holes are formed at the wafer edge as shown in FIG. 6(A).

However, as the focus ring is consumed in the course of repeated etching processes, the part of the laser beam blocked by the focus ring 11 decreases as shown in FIG. 4B, and the amount of light detected by the light receiving means 16 increases. In this state, the height of the ion sheath formed on the front surface of the focus ring is smaller than the height of the ion sheath formed on the front surface of the wafer, and thus, uneven ion sheathes are formed as shown in FIG. 5B. Since ions enter the ion sheath in the normal direction, tilted holes are formed at the wafer edge part as shown in FIG. 6(B). This phenomenon is referred to as tilt.

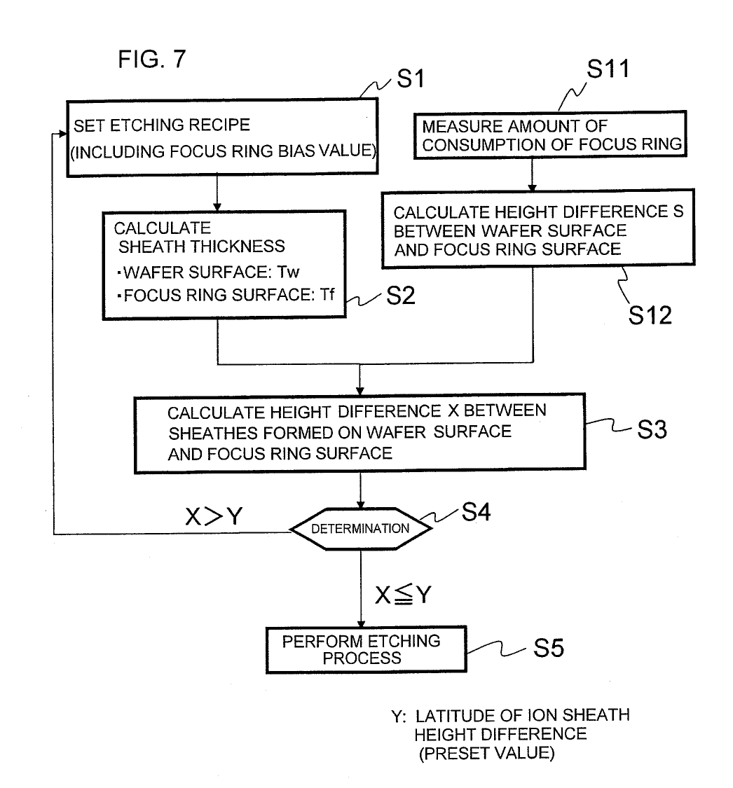

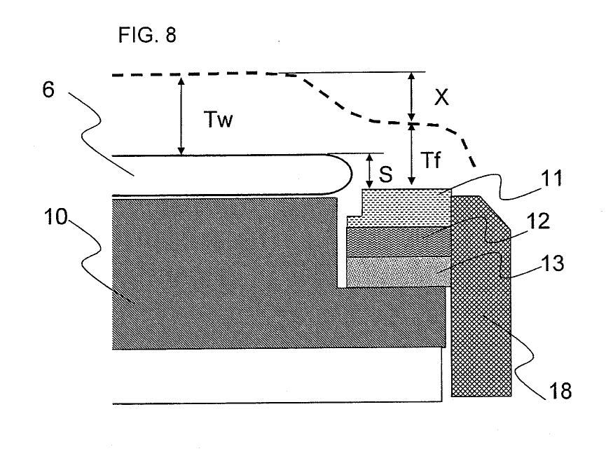

Next, a process implementing method according to the first embodiment will be described with reference to FIGS. 7 and 8. First, in an etching recipe, the gas condition, the RF bias electric power applied to the wafer, and the RF bias electric power applied to the focus ring are set (S1). Then, the wafer surface sheath thickness Tw on the wafer 6 and the focus ring surface sheath thickness Tf on the focus ring 11 are calculated based on the plasma density, the electron temperature and the RF bias voltage Vpp produced on the wafer 6 and the focus ring 11 as a result of the application of the RF bias electric power (S2). In this step, the plasma density, the electron temperature or the RF bias voltage Vpp may be determined by calculation or measurement. Meanwhile, the amount of consumption of the focus ring is measured using the laser beam as described above (S11). Based on the result of the measurement, the height difference S between the wafer surface and the focus ring surface is determined (S12), and eventually, the height difference X between the ion sheath formed on the wafer surface and the ion sheath formed on the focus ring surface is calculated (S3). Then, it is determined whether etching according to the etching recipe is allowable or not (S4). In the determination, a predetermined latitude is preferably allowed based on experimental and computational results. That is, the upper limit of the sheath height difference that does not pose any problem is previously determined based on the device structure, and the value is defined as a criterion value Y. For example, in a case where the focus ring height estimated based on the measurement of the amount of consumption of the focus ring is equal to the wafer surface height, and the sheath heights on the wafer front surface and the focus ring front surface calculated from the set values in the etching recipe are equal to each other, the sheath height difference X satisfies a relation of X<Y, and therefore, etching is carried out (S5). On the other hand, if the amount of consumption of the focus ring is high, and the ion sheath height difference X calculated based on the ion sheath thickness determined from the values set in the etching recipe satisfies a relation of X>Y, the etching recipe has to be reconfigured. In this case, the recipe is modified to satisfy the relation of X<Y by increasing the RF bias electric power applied to the focus ring 11 (S1), and then, etching is carried out.

A method of preventing a tilt by controlling the RF bias electric power applied to the focus ring based on the amount of consumption of the focus ring has been described. However, the etching process can be stopped for maintenance based on the criterion value Y and the ion sheath height difference X. The control PC (calculating means) 17 shown in FIG. 1 performs the flow described above. In FIG. 1, for the sake of simplicity, only the signal paths from the control PC 17 to the light receiving means 16 and the distributor 14 are shown, and the signal paths to the other components controlled by the control PC 17 are omitted.

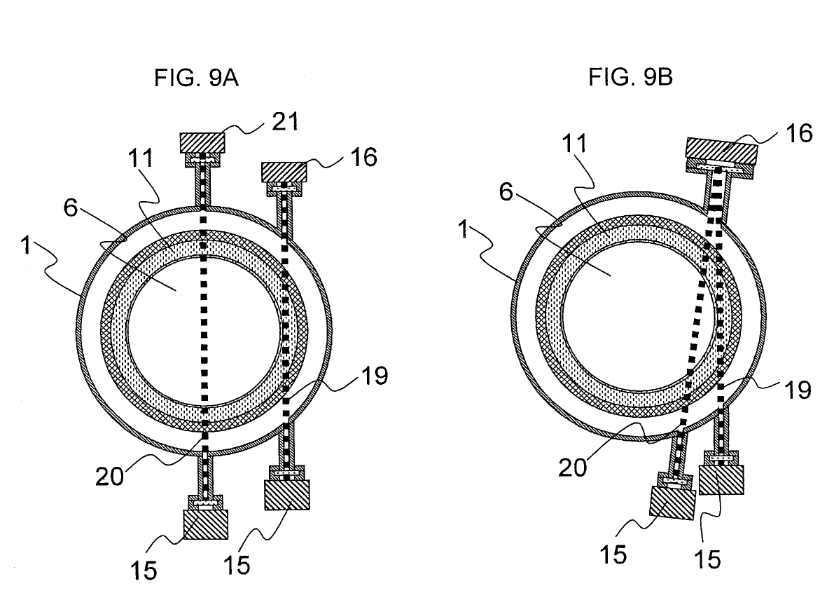

Next, another method of detecting the amount of consumption of the focus ring will be described. As shown in FIG. 9A, two pairs of light sources 15 and light receiving means 16 are provided, one of the pairs is disposed in such a manner that the laser beam passes across the surface of the wafer 6, and the other pair is disposed in such a manner that the laser beam passes across the surface of the focus ring 11. FIG. 4C is a cross-sectional view showing this case. Light receiving means 21 for a laser beam 20 traveling in parallel with the surface of the wafer 6 outputs a constant value regardless of the amount of consumption of the focus ring. On the other hand, the amount of the laser beam 19 traveling in parallel with the surface of the focus ring 11 detected by the light receiving means 16 increases because the cross-sectional area of the laser beam 19 blocked decreases as the focus ring is consumed (FIG. 4D). Therefore, once the optical axis of the laser beam and the height of the wafer surface and the focus ring surface are set, the difference between the amount of light detected by the light receiving means 16 and the amount of light detected by the light receiving means 21 can be constantly monitored. Furthermore, if Gaussian distribution of the laser beam is taken into consideration, the height difference between the surface of the focus ring 11 and the surface of the wafer 6 can be directly measured.

Alternatively, as shown in FIG. 9B, one light receiving means 16 may be provided. In that case, the height difference between the surface of the focus ring 11 and the surface of the wafer 6 can be directly measured as described above by alternately emitting light from the light source that emits the laser beam passing across the wafer surface and the light source that emits the laser beam passing across the focus ring surface.

The detection of the amount of consumption of the focus ring described in the first embodiment may be performed immediately before the start of the etching or after the completion of the etching. Furthermore, if the wavelength of the laser beam is selected to be different from the wavelength of the plasma emission, real-time measurement can also be performed during the etching without being affected by the noise of the plasma. Furthermore, if the lower electrode 5 has a lifting and lowering mechanism, measurement can be performed after the lower electrode is lowered to a level at which the lower electrode carries the wafer.

### Second Embodiment

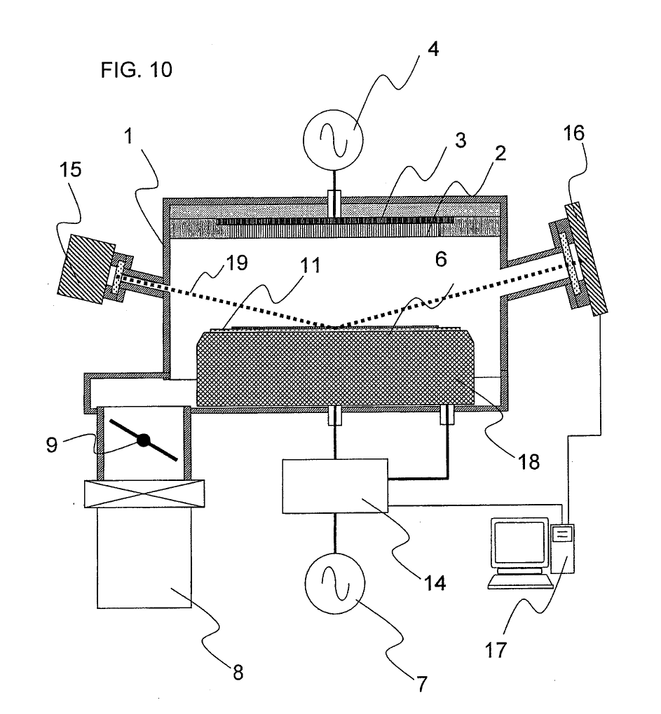

In the first embodiment, there has been described a method of detecting the amount of consumption of the focus ring using a laser beam having an optical axis parallel with the focus ring surface and the wafer surface. In a second embodiment, there will be described a method of detecting the amount of consumption of the focus ring by obliquely emitting a laser beam to the surface of the focus ring 11 and monitoring the reflected light from the surface of the focus ring 11. FIG. 10 is a schematic vertical cross-sectional view showing a configuration of a plasma processing apparatus used in this embodiment. The horizontal cross section of the plasma processing apparatus taken along the plane of the wafer is substantially the same as that shown in FIG. 2, and the horizontal cross section will be described with reference to FIG. 2. The light source 15 is installed on a side wall of the chamber to emit a laser beam onto the focus ring 11, and the light receiving means 16 is installed on a side wall of the chamber to receive the reflected light from the focus ring 11. The laser beam emitted from the light source 15 is incident on the focus ring 11 at a predetermined angle θ.

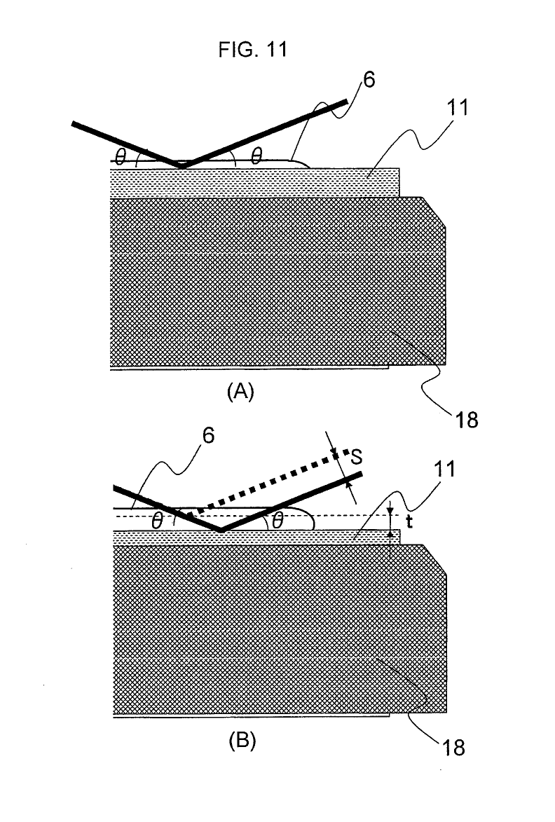

A principle of detection of the amount of consumption of the focus ring will be described with reference to FIG. 11. When the focus ring 11 is not consumed, the laser beam reflected from the focus ring 11 follows the path shown in FIG. 11(A). However, when the focus ring 11 is consumed, as shown in FIG. 11(B), the position of reflection is horizontally shifted, and therefore, the reflected laser beam is shifted in the direction perpendicular to the optical axis by S, which is expressed by the following expression (1), provided that the thickness of consumption of the focus ring 11 is t.

$$\begin{matrix}[ Expression 1 ] & \\ S = t \times \sqrt{1 + \frac{1}{{tan}^{2} θ}} \times cos ( 90 - 2 θ ) & ( 1 )\end{matrix}$$

The thickness of consumption of the focus ring 11 can be determined from the shift S detected by the light receiving means 16. In this case, the light receiving means 16 may be a CCD element or an array of a plurality of photodiodes.

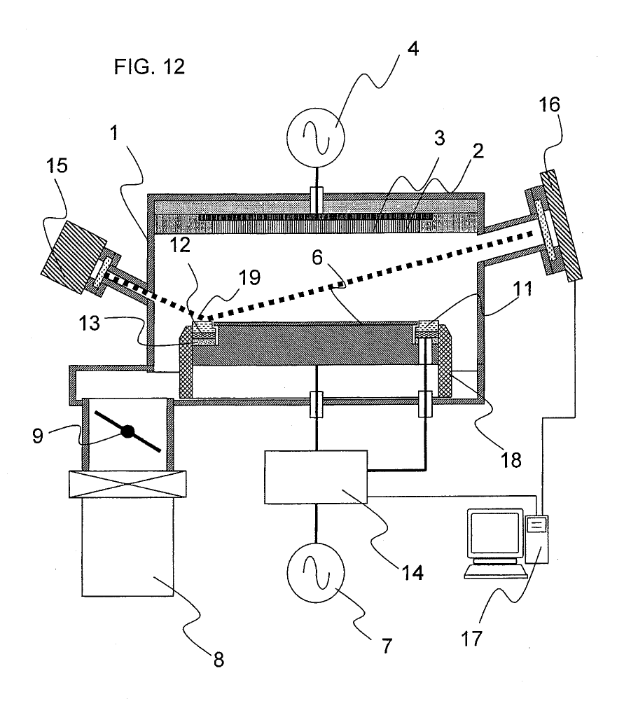

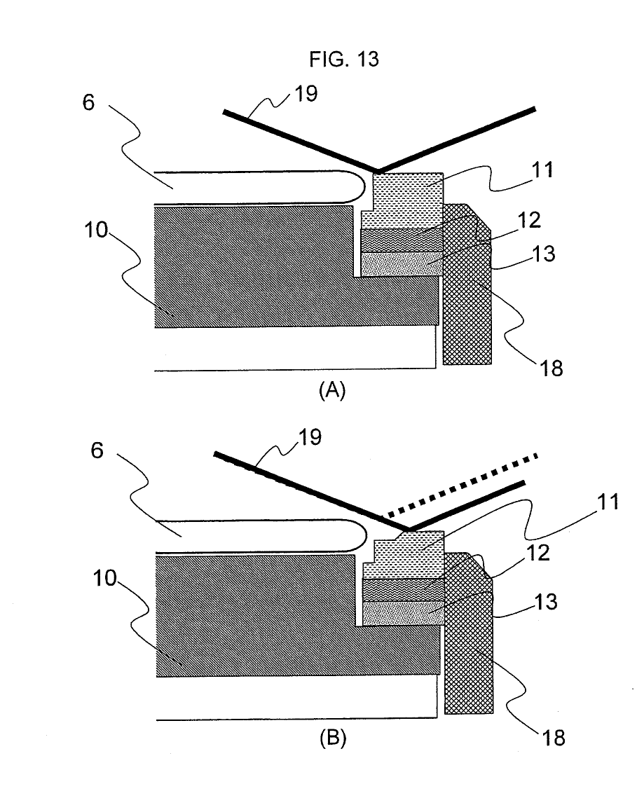

Next, another example of the arrangement of the light source 15 and the light receiving means 16 will be described. FIG. 12 is a diagram showing an arrangement in which the laser beam passes over the wafer 6. FIG. 13 includes diagrams showing laser beam paths in cases where the focus ring is consumed and where the focus ring is not consumed. In a case where the consumption of the focus ring 11 is not uniform over the surface but varies concentrically as shown in FIG. 13(B), the thickness of consumption of the focus ring actually detected can be different from the thickness of consumption of the focus ring to be detected as shown in this drawing. Therefore, in this example also, the light source 15 and the light receiving means 16 are installed at such positions that the laser beam 19 does not pass over the wafer 6 as shown in FIG. 2. With such an arrangement, if the focus ring 11 is nonuniformly consumed as shown in FIG. 13(B), that is, if the amount of consumption is greater in areas close to the wafer 6 and is smaller in areas close to the perimeter, the arrangement shown in FIGS. 2 and 10 is required, although there is no problem if the focus ring 11 is consumed uniformly over the surface thereof. Furthermore, although not shown, the part of the focus ring 11 irradiated with the laser beam can be changed so that the amount of consumption of the focus ring at a desired position is detected, and in this case, the ion sheath can be highly precisely controlled.

What is claimed is:

1. A plasma processing apparatus, comprising:
a vacuum chamber evacuated by evacuation means;
gas introducing means that introduces a source gas into the vacuum chamber;
workpiece mounting means;
high frequency electric power introducing means; and
radio-frequency bias electric power introducing means,
in which the gas introduced into the vacuum chamber by the gas introducing means is converted into a plasma by the action of a high frequency electric power introduced by the high frequency electric power introducing means, and a surface of the workpiece is processed by the plasma,
wherein the plasma processing apparatus further comprises: an annular member surrounding the workpiece mounted on the workpiece mounting means; and
a pair of tubes having an aspect ratio of 3 or higher and disposed on a side wall of the vacuum chamber to face each other,
each tube is vacuum-sealed at a tip end thereof with a glass material,
one of the tubes has a light source disposed facing to the interior of the vacuum chamber on the atmosphere side of the glass material, the other tube has light receiving means for receiving direct light from the light source disposed facing to the interior of the vacuum chamber on the atmosphere side of the glass material,
the light source is configured so that the light path from the light source is parallel with a surface of the annular member,
the light receiving means is disposed at such a position that the light receiving means receives the light from the light source, and
light passing across the surface of the annular member is received by the light receiving means disposed on the light path.

2. The plasma processing apparatus according to claim 1, further comprising:
calculating means that calculate the thickness of consumption of the surface of the annular member based on comparison between the amount of light received by the light receiving means and the amount of light previously obtained.

3. The plasma processing apparatus according to claim 1, wherein the light source is disposed in such a manner that the light path arranged to be parallel with the surface of the annular member is partially blocked by the annular member.

4. The plasma processing apparatus according to claim 1, wherein the plasma processing apparatus comprises two pairs of tubes on which the light source or the light receiving means is disposed,
the light path of one of the pairs is arranged to be parallel with the surface of the workpiece,
the light path of the other pair is arranged to be parallel with the surface of the annular member,
light passing across the surface of the workpiece and light passing across the surface of the annular member are received by the light receiving means disposed on the respective light paths, and
the plasma processing apparatus comprises calculating means that calculates the thickness of consumption of the surface of the annular member based on the amount of received light passing across the surface of the workpiece and the amount of received light passing across the surface of the annular member.

5. The plasma processing apparatus according to claim 4, wherein the two pairs share one tube on which the light receiving means is disposed.

6. The plasma processing apparatus according to claim 4 or 5, wherein the light path arranged to be parallel with the surface of the annular member is partially blocked by the annular member,
the light path arranged to be parallel with the surface of the workpiece is partially blocked by the workpiece, and
the calculating means determines the thickness of consumption of the surface of the annular member by comparison between the level of the surface of the workpiece and the level of the surface of the annular member based on the amount of received light for the respective light paths.

7. The plasma processing apparatus according to any one of claims 1 to 6, further comprising:
electric power controlling means that controls a radio-frequency bias electric power applied to the annular member independently of a radio-frequency bias electric power applied to the workpiece,
wherein the calculating means controls the radio-frequency bias electric power applied to the annular member based on the thickness of consumption of the surface of the annular member determined.

8. The plasma processing apparatus according to claim 7, wherein the calculating means increases the radio-frequency bias electric power applied to the annular member so that the difference between the thickness of a sheath formed on the surface of the annular member as a result of application of the radio-frequency bias electric power to the annular member and the thickness of a sheath formed on the surface of the workpiece separately determined is smaller than a predetermined value.

9. A plasma processing apparatus, comprising:
a vacuum chamber evacuated by evacuation means;
gas introducing means that introduces a source gas into the vacuum chamber;
workpiece mounting means;
high frequency electric power introducing means; and
radio-frequency bias electric power introducing means,
in which the gas introduced into the vacuum chamber by the gas introducing means is converted into a plasma by a high frequency electric power introduced by the high frequency electric power introducing means, and a surface of the workpiece is processed by the plasma,
wherein the plasma processing apparatus further comprises an annular member surrounding the workpiece mounted on the workpiece mounting means; and
a tube having a light source that emits light to a surface of the annular member disposed thereon and a tube having light receiving means that receives light from the light source after being reflected from the surface of the annular member disposed thereon, which are disposed on a side wall of the vacuum chamber,
the light source and the light receiving means are disposed at such positions that direct light emitted by the light source and the reflected light from the annular member do not pass over the workpiece, and
the plasma processing apparatus further comprises calculating means that measures the amount of consumption of the annular member based on a shift of the position of the direct light from the light source reflected from the annular member detected by the light receiving means.

10. The plasma processing apparatus according to claim 9, wherein the light from the light source has a wavelength that is not absorbed by silicon.

11. A plasma processing method using a plasma processing apparatus according to any one of claims 1 to 10, comprising:
a step of detecting the amount of consumption of a focus ring;
a step of calculating the thickness of ion sheathes formed on a surface of a wafer and a surface of the focus ring;
a step of calculating the height difference between the ion sheathes on the wafer and the focus ring based on the result of the calculation; and
a step of controlling a radio-frequency bias electric power applied to the focus ring taking into consideration the height difference between the ion sheathes.

12. A plasma processing method using a plasma processing apparatus comprising: a vacuum chamber evacuated by evacuation means; gas introducing means that introduces a source gas into the vacuum chamber; workpiece mounting means; high frequency electric power introducing means; radio-frequency bias electric power introducing means; and electric power controlling means that controls a radio-frequency bias electric power applied to an annular member independently of a radio-frequency bias electric power applied to a workpiece, in which the annular member is disposed to surround the workpiece mounted on the workpiece mounting means, a pair of tubes having an aspect ratio of 3 or higher are disposed on a side wall of the vacuum chamber at such positions that the tubes face each other, each tube is vacuum-sealed at a tip end thereof with a glass material, light source or light receiving means for receiving direct light from the light source is disposed on the atmosphere side of the glass material, the light path from the light source is arranged to be parallel with a surface of the annular member, light passing across the surface of the annular member is received by the light receiving means disposed on the light path thereof, the gas introduced into the vacuum chamber by the gas introducing means is converted into a plasma by the action of a high frequency electric power introduced by the high frequency electric power introducing means, and a surface of the workpiece is processed by the plasma, the plasma processing method comprising:
a step of detecting the thickness of consumption of the annular member based on the amount of light passing across the surface of the annular member; and
a step of increasing the radio-frequency bias electric power applied to the annular member based on the thickness of consumption.
